(19) United States
(12) Patent Application Publication
(10) Pub. No.: US 2021/0161061 A1
(43) Pub. Date: Jun. 3, 2021

(54) Processes For The Direct Seeding Of Coated Guayule Seeds

(71) Applicant: Bridgestone Corporation, Chuo-ku, Tokyo (JP)

(72) Inventors: Guangyao Wang, Chandler, AZ (US); David A. Dierig, Phoenix, AZ (US)

(73) Assignee: Bridgestone Corporation, Chuo-ku, Tokyo (JP)

(21) Appl. No.: 16/954,089

(22) PCT Filed: Dec. 13, 2018
(86) PCT No.: PCT/US2018/065397

§ 371 Date: Jun. 15, 2020

Related U.S. Application Data
(60) Provisional application No. 62/599,195, filed on Dec. 15, 2017.

(51) Int. Cl. A01C 7/00; A01C 5/04

(52) U.S. Cl. CPC A01C 7/002; A01C 1/06; A01C 5/04

(57) ABSTRACT

Disclosed herein are processes for direct seeding of coated guayule seeds into a field and fields produced by the processes.

### FIELD OF THE DISCLOSURE

The present disclosure relates to processes for the direct seeding of coated guayule seeds into fields and to fields produced by such processes.

### BACKGROUND

The guayule plant (Parthenium argentatum) is a woody shrub which produces rubber within its cells. Guayule plants reproduce from seed. Guayule seeds are small in size with approximately 1400-2000 (bare) guayule seeds being contained within one gram of dry seed matter. Guayule is usually established in fields by transplanting of seedlings produced from nurseries or greenhouses.

### SUMMARY

Disclosed herein are processes for direct seeding of guayule into fields and fields produced by the processes.

In a first embodiment, a process is provided for direct seeding of guayule seeds into a field. The process comprises: (a) providing guayule seeds having a coating, wherein the coating comprises at least one insecticide and one or more inert substances; (b) providing a field comprising soil with a surface; (c) applying the guayule seeds of (a) to the surface of the soil at multiple locations; and (d) allowing the guayule seeds of (c) to germinate into seedlings.

In a second embodiment, a process is provided for direct seeding of guayule seeds into a field. The process comprises: (a) providing a quantity of guayule seeds; (b) providing a field comprising soil with a surface; (c) coating the quantity of guayule seeds from (a) with a coating-mixture comprising at least one insecticide and one or more inert substances, to provide coated guayule seeds; (d) applying the coated guayule seeds of (c) to the surface of the soil at multiple locations; and (e) allowing the guayule seeds of (d) to germinate into seedlings

In a third embodiment, a field which has been directed seeded with guayule according to the process of the first or second embodiment is provided.

### DETAILED DESCRIPTION

Disclosed herein are processes for direct seeding of guayule into fields and fields produced by the processes.

In a first embodiment, a process is provided for direct seeding of guayule seeds into a field. The process comprises: (a) providing guayule seeds having a coating, wherein the coating comprises at least one insecticide and one or more inert substances; (b) providing a field comprising soil with a surface; (c) applying the guayule seeds of (a) to the surface of the soil at multiple locations; and (d) allowing the guayule seeds of (c) to germinate into seedlings.

In a second embodiment, a process is provided for direct seeding of guayule seeds into a field. The process comprises: (a) providing a quantity of guayule seeds; (b) providing a field comprising soil with a surface; (c) coating the quantity of guayule seeds from (a) with a coating-mixture comprising at least one insecticide and one or more inert substances to provide coated guayule seeds; (d) applying the coated guayule seeds of (c) to the surface of the soil at multiple locations; and (e) allowing the guayule seeds of (d) to germinate into seedlings

In a third embodiment, a field which has been directed seeded with guayule according to the process of the first or second embodiment is provided.

Definitions

The terminology as set forth herein is for description of the embodiments only and should not be construed as limiting the invention as a whole.

As used herein, the term “majority” refers to more than 50% and unless indicated to the contrary encompasses 100%.

As used herein, the term “minority” refers to less than 50% and unless indicated to the contrary encompasses 0%.

As used herein, the term “acre” refers to 4,840 square yards (with a yard corresponding to 3 feet). One acre corresponds to approximately 0.405 hectares and values presented in acres should be understood to be also disclosed in corresponding hectares.

Direct Seeding

As discussed above, the processes of the first and second embodiments disclosed herein are directed to direct seeding of coated guayule seeds into a field. Direct seeding involves placement of seeds directly into the soil of a field in which the seeds germinate and grow into plants. Direct seeding can be contrasted with the placement of seedlings into a field, which seedlings may have been originally grown from seeds planted in a medium located in a greenhouse. According to the first and second embodiments, coated guayule seeds are used in the direct seeding process. More specifically, according to the first and second embodiments, coated guayule seeds are applied to the surface of the soil of a field at multiple locations. In other words, the processes of the first and second embodiments comprise applying coated guayule seeds to the soil at multiple locations. In certain embodiments of the first and second embodiments, the coated guayule seeds are applied in spaced intervals to rows; in certain such embodiments, each row (or bed of the row) is spaced about 20 to about 80 inches apart or 20-80 inches apart (e.g., 20, 22, 24, 26, 28, 30, 32, 34, 36, 38, 40, 42, 44, 46, 48, 50, 52, 54, 56, 58, 60, 62, 64, 66, 68, 70, 72, 74, 76, 78, or 80 inches apart), preferably about 30 to about 50 inches apart or 30-50 inches apart, or about 30 to about 42 inches apart or 30-42 inches apart. In certain embodiments of the first and second embodiments, the coated guayule seeds are applied in spaced intervals to rows; in certain such embodiments, each row (or bed of the row) is spaced about 50 to about 200 centimeters apart or 50-200 centimeters apart (e.g., 50, 55, 60, 65, 70, 75, 80, 85, 90, 95, 100, 110, 120, 130, 140, 150, 160, 170, 180, 190, or 200 centimeters apart), preferably about 75 to about 120 centimeters apart or 75-120 centimeters apart, or about 75 to about 105 centimeters apart or 75-105 centimeters apart. As used herein, spacing between beds or rows refers to spacing from the center of one row or bed to the center of an adjacent row or bed. In those embodiments of the first and second embodiments wherein the soil to which the coated guayule seeds are applied has been plowed into raised beds, the foregoing row spacing refers to the distances between center points of each bed. In certain embodiments of the first and second embodiments, the coated guayule seeds are applied in rows and the coated guayule seeds within a given row are linearly spaced about 0.5 to about 36 inches apart or 0.5-36 inches apart (e.g., 0.5, 1, 2, 4, 6, 8, 10, 12, 14, 16, 18, 20, 22, 24, 26, 28, 30, 32, 34, or 36 inches apart), preferably about 6 to about 24 inches apart or 6-24 inches apart, or about 10 to about 18 inches apart or 10-18 inches apart. In certain embodiments of the first and second embodiments, coated guayule seeds are applied in rows and the coated guayule seeds within a given row are linearly spaced about 1 to about 90 centimeters apart or 1-90 centimeters apart (e.g., 1, 5, 10, 15, 20, 25, 30, 35, 40, 45, 50, 55, 60, 65, 70, 75, 80, 85, or 90 centimeters apart), preferably about 15 to about 60 centimeters apart or 15-60 centimeters apart, or about 25 to about 45 centimeters apart or 25-45 centimeters apart. In order to facilitate placement of the coated guayule seeds into one or more of the foregoing spaced intervals, the soil of the field may be plowed into rows having raised beds and furrows (as discussed further infra). Alternatively, the soil of the field may be plowed into rows, but without any raised beds; in other words, in such embodiments, the rows comprise flat surfaces. In those embodiments of the first and second embodiments where the coated guayule seeds are applied to soil having a flat surface, the applied guayule seeds may be covered with soil (as discussed below), may be allowed to remain upon the surface of the soil without covering with soil, or may be pressed into the soil (as discussed below).

According to the processes of the first and second embodiments, the number of coated guayule seeds that are applied to each location of the soil may vary. In certain embodiments of the first and second embodiments, one coated guayule seed is applied to each location of the soil, as discussed above (e.g., in spaced intervals in a row). In other embodiments of the first and second embodiments, one to three coated guayule seeds are applied to each location of the soil as discussed above (e.g., in spaced intervals in a row). In certain embodiments of the first and second embodiments, the number of coated guayule seeds applied to each location, as discussed above, can be understood as referring to an average taken from 100 locations. As a non-limiting example, if 100 locations were examined to determine the number of coated guayule seeds and 98 locations contained one seed and locations contained 2 seeds, the average number of coated guayule seeds applied can be considered to be 1.02 which rounds to 1.

According to the processes of the first and second embodiments, the rate at which the coated guayule seeds are applied to the soil may vary. In certain embodiments of the first and second embodiments, the coated guayule seeds are applied at a rate of about 50,000 coated seeds to about 2,000,000 coated seeds per acre of field (e.g., 50,000; 100,000; 200,000; 300,000; 400,000; 500,000; 600,000; 700,000; 800,000; 900,000; 1,000,000; 1,100,000; 1,200,000; 1,300,000; 1,400,000; 1,500,000; 1,600,000; 1,700,000; 1,800,000; 1,900,000; or 2,000,000 seeds per acre of field) and in other embodiments about 100,000 to about 300,000 coated seeds per acre of field (e.g., 100,000; 150,000; 200,000; 250,000; or 300,000 coated seeds per acre of field.

As mentioned above, according to the processes of the first and second embodiments disclosed herein, the coated guayule seeds are applied to the surface of the soil of the field. In certain embodiments of the first and second embodiments, the soil of the field includes one or more depressions and the coated guayule seeds are applied to the depressions of the soil; in certain such embodiments, the one or more depressions are one or more grooves. In certain embodiments of the first and second embodiments, the surface of the soil contains one or more depressions onto which the coated guayule seeds are placed; when present such depressions extend no more than 1 inch into the soil (e.g., no more than 1 inch, no more than 0.9 inches, no more than 0.8 inches, no more than 0.7 inches, no more than 0.75 inches or ¾ inch, no more than 0.6 inches, no more than 0.5 inches or ½ inch, no more than 0.4 inches, no more than 0.3 inches, no more than 0.2 inches, no more than 0.125 inches or ⅛ inch, or no more than 0.1 inches), preferably no more than 0.8 inches or even no more than 0.5 inches and generally will have a depth of about 1 to about 0.125 inches, 1-0.125 inches (e.g., 1 inch, 0.9 inches, 0.8 inches, 0.7 inches, 0.75 inches or ¾ inch, 0.6 inches, 0.5 inches or ½ inch, 0.4 inches, 0.3 inches, 0.2 inches, 0.125 inches or ⅛ inch, or 0.1 inches), about 0.125 to about 0.75 inches, 0.125-0.75 inches, preferably about 0.2 to about 0.5 inches or 0.2 to 0.5 inches. In certain embodiments of the first and second embodiments, the surface of the soil contains one or more depressions onto which the coated guayule seeds are placed; when present such depressions extend no more than 2.5 centimeters into the soil, no more than 2 centimeters into the soil or no more than 1.2 cm into the soil, and generally will have a depth of about 2.5 to about 0.3 centimeters, 2.5-0.3 centimeters (e.g., 2.5, 2.2, 2, 1.8, 1.5, 1.2, 1, 0.8, 0.5, 0.3, or 0.2 centimeters), about 0.3 to about 2 centimeters, 0.3-2 centimeters, preferably about 0.5 to about 1.2 centimeters. In those embodiments of the first and second embodiments wherein the coated guayule seeds are applied to depressions or grooves in the soil, the coated guayule seeds are preferably covered with soil. In other embodiments of the first and second embodiments, the coated guayule seeds are placed onto a flat soil surface (i.e., no soils has not been prepared with any grooves or depressions); in certain such embodiments, the coated guayule seeds are pressed into the soil to a depth of no more than 1 inch (e.g., no more than 1 inch, no more than 0.9 inches, no more than 0.8 inches, no more than 0.7 inches, no more than 0.75 inches or ¾ inch, no more than 0.6 inches, no more than 0.5 inches or ½ inch, no more than 0.4 inches, no more than 0.3 inches, no more than 0.2 inches, no more than 0.125 inches or ⅛ inch, or no more than 0.1 inches), preferably no more than 0.8 inches or even no more than 0.5 inches.

In certain embodiments of the first and second embodiments, the field soil onto which the coated guayule seeds are applied has been prepared for planting by one or more of plowing, discing, leveling, listing, or bed-shaping. In certain embodiments of the first and second embodiments, the prepared soil comprises rows of furrows and beds (with the furrows separating the beds) and the coated guayule seeds are applied to the beds. In certain embodiments of the first and second embodiments, the beds are raised beds which have a surface height about 2 to about 8 inches above, 2-8 inches above, about 4 to about 6 inches above, or 4-6 inches above the depth of the furrows between the rows; in certain such embodiments each raised bed is about 10 to about 60 inches wide, or 10-60 inches wide (e.g., 10 inches, 20 inches, 24 inches, 25 inches, 30 inches, 35 inches, 36 inches, 40 inches, 45 inches, 48 inches, 50 inches, 55 inches, or 60 inches). In certain embodiments of the first and second embodiments, the beds are raised beds which have a surface height about 5 to about 20 centimeters above, 5-20 centimeters above, about 10 to about 15 centimeters above, or 10-15 centimeters above the depth of the furrows between the rows; in certain such embodiments each raised bed is about 25 to about 150 centimeters wide or 25-150 centimeters wide (e.g., 25, 30, 35, 40, 50, 55, 60, 65, 70, 75, 80, 85, 90, 95, 100, 110, 120, 130, 140, or 150 centimeters wide). Generally, the bed or raised bed will have a flat surface rather than a peaked or triangular surface.

According to the first and second embodiments, the day or days of the year when the coated guayule seeds are applied to the soil may vary. In certain embodiments of the first and second embodiments, the coated guayule seeds are applied on a day or days when the mean daily air temperature ranges from 50 to 90° F. (e.g., 50, 55, 60, 65, 70, 75, 80, 85, or 90° F. or 10 to 32° C. (e.g., 10, 12, 14, 16, 18, 20, 22, 24, 26, 28, 30, or 32° C.). Planting during a period of time when the mean daily air temperature is between the foregoing ranges will be more favorable to germination of the guayule seeds than planting when the mean daily air temperature is lower or higher.

Coated Guayule Seeds

As mentioned above, the process of the first embodiment includes providing guayule seeds having a coating and the process of the second embodiment includes coating a quantity of guayule seeds to provide coated guayule seeds. While the first embodiment refers to guayule seeds having a coating, such seeds can also be described as coated guayule seeds. According to the first and second embodiments, the coating of the coated guayule seeds comprises (includes) at least one insecticide and one or more inert substances. As explained in more detail below, the particular insecticide(s) used and the particular inert substances used or present in the coating may vary. Although the phrase “coated guayule seed” is used infra in singular form, it should be understood that an individual coated guayule seed is not limited to containing only one uncoated or bare guayule seed inside the coating. Rather, a coated guayule seed may include one or more than one (e.g., 2, 3, or 4) uncoated or bare guayule seeds inside its coating. However, for reasons of economy and efficiency, it may be preferred for each coated guayule seed to include an average of only one uncoated or bare guayule seed inside the coating. The average number of uncoated or bare guayule seeds inside coated guayule seeds may be determined by analyzing a given number of coated guayule seeds (e.g., 100 coated guayule seeds) chosen at random from a larger quantity of guayule seeds and determining the average.

Various inert substances can be used in the coating of the coated guayule seeds. Generally, suitable inert substances will be powdered or consist of small size particles capable of flowing or pouring. In certain embodiments of the first and second embodiments, the inert substance of the coating includes one or more of clay, diatomaceous earth, talcum, pumice, gypsum, perlite, or chalk; in certain such embodiments, the coating comprises a majority by weight of one or more of the foregoing inert substances. Various clays are suitable for use as an inert substance in the coating of the coated seeds according to the first and second embodiments. In certain embodiments of the first and second embodiments, the at least one inert substance of the coating includes a clay selected from the group consisting of montmorillonite, kaolin, bentonite, Fuller's earth, zeolite, and combinations thereof. In certain embodiments of the first and second embodiments, the only inert substance used in the coating is one or more clays, preferably selected from the foregoing list.

In certain embodiments of the first and second embodiments, the coating of the coated guayule seeds further comprises (i.e., includes in addition to the at least one insecticide and one or more inert substances) one or more additional ingredients. These additional ingredients may vary. In other embodiments of the first and second embodiments, the coating of the coated guayule seeds further comprises at least one binder; in certain such embodiments, the at least one binder comprises at least one of cellulose powder, polyacrylate, silicone, polyvinyl alcohol, polyvinylpyrrolidone, or polyvinylchloride.

According to the processes of the first and second embodiments, the at least one insecticide that is used in or present in the coating may vary. In certain embodiments of the first and second embodiments, insecticide is applied to the guayule seeds after the seed germination treatment. Various insecticides may be utilized according to the processes of the first and second embodiments, including, but not limited to clothianidin, acetamiprid, nitenpyram, nithiazine, and thiacloprid. One or more than one of the foregoing insecticides may be utilized, or one or more of the foregoing insecticides may be utilized in combination with another insecticide. In those embodiments of the first and second embodiments wherein an insecticide is utilized or present on the coated guayule seeds, the rate at which the insecticide is used may vary. In certain embodiments of the first and second embodiments, the insecticide is used at an active ingredient rate of 20 grams to 150 grams (e.g., 20, 25, 30, 35, 40, 45, 50, 55, 60, 65, 70, 75, 80, 85, 90, 95, 100, 105, 110, 115, 120, 125, 130, 135, 140, 145, or 150 grams) per 150 grams of seed, preferably 25 to 100 grams or 30 to 90 grams per 150 grams of seed, with the 150 grams of seed referring to the weight of uncoated seed. When measuring or determining a rate of insecticide treatment, the guayule seed has preferably been dried to a moisture content of no more than 10% by weight water (e.g., 10%, 9%, 8%, 7%, 6%, 5%, 4%, 3%, 2%, or 1%) so that excess water is not included in the seed weight. Various drying methods may be utilized such as drying at room temperature, drying in a seed dryer, and drying at outside ambient temperature (optionally in the sun); preferably, any drying method employed will utilize a temperature of no more than about 95° F. (no more than 35° C.).

As discussed above, the process of the second embodiment includes coating a quantity of guayule seeds with a coating-mixture comprising at least one insecticide and one or more inert substances. According to the first and second embodiments, the coating on the guayule seeds may be present as one or more than one layer. Thus, according to the process of the second embodiment, one or more than one coating-mixture may be used to apply one or more layers of coating. Generally, the coating-mixture which includes one or more inert substances will also include one or more liquids such as water. The viscosity of the coating-mixture which includes one or more inert substances can vary, but will generally include sufficient liquid to produce a paste from the dry ingredients. In certain embodiments of the second embodiment, the at least one insecticide may be applied via a liquid coating-mixture prior to application of the coating-mixture which includes the one or more inert substances, after application of the coating-mixture which includes the one or more inert substances, or both before and after. Alternatively, in other embodiments of the second embodiment, the at least one insecticide may be applied via a liquid coating-mixture which also includes the one or more inert substances. Generally, when the coating-mixture of the second embodiment includes one or more liquids, application of the coating-mixture to the guayule seeds may be followed by drying. In certain embodiments of the second embodiment, the drying comprises drying to a moisture content of no more than 10% (e.g., 10%, 9%, 8%, 7%, 6%, 5%, 4%, 3%, 2%, or 1%). Various drying methods may be utilized such as drying at room temperature, drying in a seed dryer, and drying at outside ambient temperature (optionally in the sun); preferably, any drying method employed will utilize a temperature of no more than about 95° F. (no more than 35° C.). The coating-mixture can be coated onto the uncoated guayule seeds by various methods including, but not limited to, using commercial seed coating machinery. The coating which is present on the coated seeds which are provided as part of the first embodiment may be produced according to a similar process as discussed above, or by a different process.

The amount of coating that is present upon the coated seeds according to the first and second embodiments may vary. In certain embodiments of the first and second embodiments, the coating is present in an amount of 40 to 3 grams per gram of seed (e.g., 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, or 3 grams per gram of seed), preferably 30 to 5 grams per gram of seed (e.g., 30, 28, 26, 24, 22, 20, 18, 16, 14, 12, 10, 8, 6, or 5 grams per gram of seed). The grams of coating per gram of seed refers to the amount of coating added to bare or uncoated seed and can be calculated by weighing a quantity of uncoated seed before coating and then re-weighing after coating and drying to a moisture content of no more than 10%. As a non-limiting example, if a quantity of uncoated seed weighed 5 grams and the coated and dried version of that seed weighed 100 grams, then the coating would be described as being present in an amount of 20 grams per gram of seed. Generally, a larger amount of coating per given quantity of seed can be understood as resulting in larger coated seeds. According to the first and second embodiments, the size of the coated guayule seeds may vary. In certain embodiments of the first and second embodiments, the size of the coated guayule seeds can be understood in terms of their cross-dimensional size which refers to the size of the widest or longest dimension; in certain such embodiments, the coated guayule seeds have a diameter of no more than 0.4 cm (e.g., no more than 0.4 cm, no more than 0.3 cm, no more than 0.2 cm, no more than 0.1 cm, no more than 0.05 cm, etc), preferably no more than 0.3 cm. When the coated guayule seeds have a non-circular shape (e.g., ovular shape), the diameter refers to the width rather than the length, with the width being lesser than the length. In certain embodiments of the first and second embodiments, the coated guayule seeds have sufficient coating to result in a film-coated seed, an encrusted seed, or a pelletized seed (of the three foregoing coated seed types, the film-coated seed is generally regarded as the smallest and the pelletized seed is generally regarded as the largest).

Treated Guayule Seeds and Guayule Seeds

In certain embodiments of the first and second embodiments, the guayule seeds are treated prior to coating. By treated is meant that the seeds have been exposed to a seed germination treatment. The particular type or types of seed germination treatment used to treat the guayule seeds may vary. Generally, the seed germination treatment will comprise a treatment which breaks dormancy and increases germination (speed of germination, success rate of germination, or both) of the seed. In certain embodiments of the first and second embodiments, the seed germination treatment comprises a chemical treatment. Various seed germination treatments are known to those of skill in the art and can be applied to guayule seeds. In certain embodiments of the first and second embodiments, the seed germination treatment comprises application of and/or soaking of guayule seeds with at least one of the following: (a) water, (b) plant growth regulator such as gibberellic acid (e.g., GA3, GA7, GA4); (c) potassium nitrate (i.e., KNO₃); (d) bleach solution (e.g., water solution of sodium hypochlorite (NaClO), calcium hypochlorite (Ca(ClO)₂, or a combination thereof at a concentration of 2-10% or 4-8%). Generally, when one or more of the foregoing is utilized as a seed germination treatment, liquid application is used (e.g., by dissolving the compound(s) in water or another liquid solvent).

In those embodiments of the first and second embodiments wherein the seed germination treatment comprises use of a plant growth regulator such as discussed above, the concentration of the plant growth regulator in any liquid application may vary and the time of contact between the liquid and the guayule seeds may vary. In certain embodiments of the first and second embodiments, the concentration of plant growth regulator is about 0.1 mmoles/liter to about 1 mmoles/liter or 0.1-1 mmoles/liter (e.g., 0.1, 0.2, 0.3, 0.4, 0.5, 0.6, 0.7, 0.8, 0.9, 1 mmoles/liter), preferably about 0.4 mmoles/liter to about 0.8 mmoles/liter or 0.4-0.8 mmoles/liter; in certain embodiments of the foregoing, the liquid solvent utilized is water and the foregoing refers to the amount of plant growth regulator used per liter of water. In certain embodiments of the first and second embodiments, gibberellic acid is dissolved in alcohol (e.g., isopropanol) prior to mixing with water. In certain embodiments of the first and second embodiments, the plant growth regulator is used at one of the foregoing concentrations and the guayule seeds are allowed to soak for about 0.5 to about 6 hours, or 0.5-6 hours (e.g., 0.5, 1, 1.5, 2, 2.5, 3, 3.5, 4, 4.5, 5, 5.5, or 6 hours), preferably 1 to about 3 hours or 1-3 hours; in certain such embodiments soaking is followed by draining and drying at room temperature. In certain embodiments of the first and second embodiments, gibberellic acid (e.g., GA3) is used at one of the foregoing concentrations and/or for one of the foregoing times.

According to the processes of the first and second embodiments, there is no need for the coated guayule seeds to be allowed to sprout or start to sprout prior to applying them to the soil of the field at multiple locations. Accordingly, in certain embodiments of the first and second embodiments, the coated guayule seeds that are applied to the field can be considered non-sprouted.

In preferred embodiments of the processes of the first and second embodiments, the guayule seeds which are utilized (i.e., which are coated) have been cleaned to increase the density of viable seed in a given quantity prior to coating. Such cleaning may generally include removal of non-seed plant matter (e.g., flowers and leaves) and/or removal of less dense seed. In certain embodiments of the processes of the first and second embodiments, the guayule seeds which are treated have a density which is quantified by a measurement referred to as 100 seed weight. This measurement refers to the weight (in grams) of 100 seeds. In certain embodiments of the processes of the first and second embodiments, the guayule seeds which are treated have a 100 seed weight of at least 0.04 grams. In certain embodiments of the processes of the first and second embodiments, the guayule seeds which are treated have a 100 seed weight of 0.04 grams to 0.1 grams (e.g., 0.04, 0.05, 0.06, 0.07, 0.08, 0.09, or 0.1 grams), preferably 0.5 grams to 0.1 grams. The 100 seed weights referred to herein can be determined by determining the weight of 100 seeds, preferably after drying the seeds to a moisture content of no more than 10% by weight. In certain embodiments of the processes of the second embodiment, the process includes a step of providing a quantity of guayule seeds having a 100 seed weight as described above and then coating the quantity of seeds (i.e., with a coating-mixture, as discussed above), and optionally treating the guayule seeds prior to coating (i.e., with a seed germination treatment, as discussed above).

Fields and Soil

As mentioned above, the processes of the first and second embodiments comprise applying coated guayule seeds to the soil of a field. According to the first and second embodiments, a field is provided which comprises soil with an exposed surface. The size of the field may vary, as discussed below. According to the first and second embodiments, the composition of the soil in the field may vary.

As mentioned above, the processes of the first and second embodiment comprise direct seeding of coated guayule seeds into a field and include providing a field comprising soil with an exposed surface. The field represents the location where the applied coated guayule seeds will germinate into seedlings and where those seedlings will grow into guayule shrubs (i.e., without any transplanting of the seedlings). The field also represents the location at which the guayule shrubs grown from the seedlings are ultimately harvested for their rubber-containing biomass. According to the first-third embodiments, the size of the field may vary, but will generally be greater than 1 acre in size. In certain embodiments of the first-third embodiments, the field is greater than 5 acres in size (e.g., 5-500, 5, 10, 20, 50, 100, 200, 300, 400 or 500 acres), greater than 10 acres in size, greater than 20 acres in size, or greater than 100 acres in size. The fields utilized in the processes of the first and second embodiments and present in the third embodiment contain soil that is exposed to the environment rather than being partially or entirely protected such as in a greenhouse.

As mentioned above, the third embodiment disclosed herein is directed to a field direct seeded with guayule according to the process of the first embodiment or the second embodiment. Depending upon the number of days that have passed from the time of applying the coated guayule seeds to the field, the field will contain guayule seedlings or guayule shrubs. Embodiments of the third embodiment corresponding to the results achieved by the processes of the first and second embodiment (e.g., planting intervals, soil in rows, coating rate and ingredients, etc.) should also be considered to be fully disclosed. Also included herein as the third embodiment are fields having the seedling and location rates discussed infra with respect to the processes of the first and second embodiments.

Applying to the Soil

As mentioned above, the processes of the first and second embodiments comprise applying coated guayule seeds to the soil at multiple locations. In certain embodiments of the first and second embodiments, the applying comprises mechanical application to the field, e.g., using one or more machines. Suitable machinery for applying the coated guayule seeds to the soil are commercially available including planters which may apply coated guayule seeds to one row at a time or to multiple rows at the same time; certain such planters may utilize a disk with one or more holes in combination with a vacuum to extract coated guayule seeds from a hopper and transport them to a target location.

According to the processes of the first and second embodiments, the rate at which the coated guayule seeds are applied to the soil of the field may vary. In certain embodiments of the first and second embodiments, the applying comprises mechanical application of the coated guayule seeds to at least 2 acres/hour (e.g., 2, 3, 4, 5, 6, 7, 8, 9, 10, 11, 12, 13, 14, 15, 16, 17, 18, 19, 20, or more acres/hour)of the field, preferably about 3 to about 20 acres/hour (e.g., 3, 4, 5, 6, 7, 8, 9, 10, 11, 12, 13, 14, 15, 16, 17, 18, 19, or 20 acres/hour) or 5-15 acres/hour of the field.

Pressing

As mentioned above, in certain embodiments of the processes of the first and second embodiments, the applied coated guayule seeds are pressed into the soil. When pressing is utilized, it may take place after the coated guayule seeds are applied to the soil (i.e., applied to the soil and then pressed into the soil) or commensurate with applying the coated guayule seeds to the soil. In certain embodiments of the first and second embodiments, pressing of the applied guayule seeds into the soil is performed. In other embodiments of the first and second embodiments, pressing of the applied guayule seeds into the soil is not performed. Without being bound by theory, it is believed that pressing can be advantageous to germination by reducing loss and disturbance of the coated guayule seeds (e.g., by wind and/or water). However, care must be taken during the pressing to ensure that the pressure applied does not push the coated guayule seeds too far beneath the surface or too far into the underlying soil which may hamper germination. Generally, the pressing will entail pressing down or compressing of the coated guayule seeds into the soil by no more than about 1 inch, by no more than 1 inch (e.g., no more than 1 inch, no more than 0.9 inches, no more than 0.875 inches or ⅞ inches, no more than 0.8 inches, no more than 0.75 inches or ¾ inches, no more than 0.7 inches, no more than 0.625 inches or ⅝ inches, no more than 0.6 inches, no more than 0.5 inches or ½ inch, no more than 0.4 inches, no more than 0.375 inches or ⅜ inches, no more than 0.3 inches, no more than 0.25 inches or ¼ inches, no more than 0.2 inches, no more than 0.125 inches or ⅛ inches, or no more than 0.1 inches), by about ⅛ to about 1 inch, by ⅛ to 1 inch (e.g., 1 inch, 0.9 inches, 0.875 inches or ⅞ inches, 0.8 inches, 0.75 inches or ¾ inches, 0.625 inches or ⅝ inches, 0.6 inches, 0.5 inches or ½ inch, 0.4 inches, 0.375 inches or ⅜ inches, 0.3 inches, 0.2 inches, or 0.125 or ⅛ inches), by about ¼ to about ¾ inches, or by ¼ to ¾ inches. According to a metric scale, generally, the pressing will entail pressing down or compressing of the coated guayule seeds into the soil by no more than about 2.5 centimeters, by no more than 2.5 centimeters (e.g., no more than 2.5, no more than 2.2, no more than 2, no more than 1.8, no more than 1.5, no more than 1.2, no more than 1, no more than 0.8, no more than 0.5, no more than 0.3, or no more than 0.2 centimeters), by about 0.3 to about 2.5 centimeters or 0.3-2.5 centimeters (e.g., 2.5, 2.2, 2, 1.8, 1.5, 1.2, 1, 0.8, 0.5, 0.3, centimeters), by about 0.6 to about 1 centimeters, or by 0.6-1 centimeters. According to the first and second embodiments, various types of pressing may be utilized. In certain embodiments of the first and second embodiments, the pressing comprises pressing by rolling (e.g., by use of a wheel), by stamping, or a combination thereof.

Germination and Seedlings

As mentioned above, according to the processes of the first and second embodiments, the coated guayule seeds that have been applied to multiple locations of the soil are allowed to germinate into seedlings. The seedlings will then grow (within the field) into guayule shrubs. Processes according to the first and second embodiment generally result in a relatively high germination rate. The germination rate can be measured in terms of the number of seedlings per area (referred to herein as a stand count). In certain embodiments of the first and second embodiments, the stand count is at least 1 seedling per square meter (e.g., 1, 2, 3, 4, 5, 6, 7, 8, 9, 10, 11, 12, 13, 14, 15, 16, 17, 18, 19, 20, 21, 22, 23, 24, 25, or more seedlings per m²), preferably at least 3 or at least 5 seedlings/m². The stand count is preferably determined 8-10 days after the coated guayule seeds were applied to the soil. A range of more than one day is provided since counting may need to be conducted during more than one day, and/or sections of a given field may have been planted over the course of a couple of days. To the extent that it is deemed necessary to conduct the counting on a single day, it should be conducted upon the 9^{th} day after planting. As used herein, a seedling will have at least two cotolyden leaves (spread apart or open) and a root portion (radicle) extending into the soil. Measurements of the stand count taken more than 10 days after the coated guayule seeds were applied to the soil may yield lower measurement rates due to seedlings dying from any combination of factors (e.g., excessive water, too little water, fungus, pests).

Irrigating

In certain embodiments of the first and second embodiments, the process further comprises irrigating to apply water to the coated guayule seeds at the multiple locations within the field. Depending upon the local conditions at the particular field in question, irrigation may or may not be necessary. In those embodiments of the first and second embodiments wherein irrigation is utilized, the type of irrigation may vary. Exemplary forms of irrigation that may be suitable include, but are not limited to, center pivot (also known as central pivot), linear move, traveling gun, solid set (portable), permanent set, micro-irrigation (e.g., drip or micro-sprinkler), drip irrigation (e.g., surface drip, subsurface drip), furrow, basin, or border. In certain embodiments of the first and second embodiments, the irrigation comprises overhead irrigation; in certain such embodiments, the overhead irrigation comprises central pivot irrigation or solid-set irrigation. In certain embodiments of the first and second embodiments, the irrigation comprises surface irrigation; in certain such embodiments, the surface irrigation comprises furrow irrigation, basin irrigation, or border irrigation. Surface irrigation generally refers to irrigation whereby the water is distributed by gravity over the surface of a field. In certain embodiments of the first and second embodiments, irrigation is applied within 2 day(s) of applying the coated guayule seeds to the field; in certain such embodiments, irrigation is applied for an additional 5-8 days in an amount sufficient to maintain the surface of the soil surrounding the coated guayule seeds moist (although preferably the creation of standing water is avoided). As non-limiting examples, irrigation may be applied on each of days 1-8 after applying the coated guayule seeds to the field or on each of days 2-7 after applying the coated guayule seeds to the field.

### EXAMPLES

The following examples illustrate specific and exemplary embodiments and/or features of the embodiments of the present disclosure. The examples are provided solely for the purposes of illustration and should not be construed as limitations of the present disclosure. Numerous variations over these specific examples are possible without departing from the spirit and scope of the presently disclosed embodiments. It should specifically be understood that different rates of applying coated guayule seeds to the soil, different coating rates or weights as well as coating ingredients, other seed germination treatments, as well as different methods of applying and different methods of pressing other than those utilized in the Examples can be utilized (i.e., as fully disclosed in the preceding paragraphs).

### Examples 1-4

Coated guayule seeds were utilized having a coating rate of 16.5 grams per gram of seed. The effects of planting depth on stand count was investigated by applying the coated guayule seeds to soil in single rows at a depth of either 0 inches (i.e., top of the soil surface), at a depth of 0.25 inches, at a depth of 0.5 inches, or at a depth of 0.75 inches. The coated guayule seeds which were planted at a depth were applied to grooves having the indicated depth and then covered with soil. Furrow irrigation was utilized beginning on the day after planting. The stand count was measured 10 days after planting. Data is presented below in Table 1. As can be seen from the data of Table 1, a planting depth of 0.25 inches resulted in the best stand count.

TABLE 1

| Planting depth (inches) | Stand count (seedlings/m²) |
|---|---|
| 0 | 14 |
| 0.25 | 17 |
| 0.5 | 10 |
| 0.75 | 5 |

This application discloses several numerical range limitations that support any range within the disclosed numerical ranges, even though a precise range limitation is not stated verbatim in the specification, because the embodiments of the compositions and methods disclosed herein could be practiced throughout the disclosed numerical ranges. With respect to the use of substantially any plural or singular terms herein, those having skill in the art can translate from the plural to the singular or from the singular to the plural as is appropriate to the context or application. The various singular or plural permutations may be expressly set forth herein for sake of clarity.

It will be understood by those within the art that, in general, terms used herein, and especially in the appended claims are generally intended as “open” terms. For example, the term “including” should be interpreted as “including but not limited to,” the term “having” should be interpreted as “having at least,” the term “includes” should be interpreted as “includes but is not limited to.” It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references, including but not limited to patents, patent applications, and non-patent literature are hereby incorporated by reference herein in their entirety.

While various aspects and embodiments of the compositions and methods have been disclosed herein, other aspects and embodiments will be apparent to those skilled in the art. The various aspects and embodiments disclosed herein are for purposes of illustration and are not intended to be limiting, with the true scope and spirit being indicated by the claims.

1-15. (canceled)

16. A process for direct seeding of guayule seeds into a field comprising
a. providing guayule seeds having a coating, wherein the coating comprises at least one insecticide and one or more inert substances;
b. providing a field comprising soil with a surface;
c. applying the guayule seeds of (a) to the surface of the soil at multiple locations; and
d. allowing the guayule seeds of (c) to germinate into seedlings.

17. The process of claim 16, wherein the applied guayule seeds of (c) are pressed into the soil.

18. The process of claim 16, wherein the applied guayule seeds of (c) are covered with soil to a depth of no more than 1 inch.

19. The process of claim 16, wherein (d) results in a stand count of at least 1 seedling/m².

20. The process of claim 16, wherein the coating comprises a majority by weight of one or more inert substances selected from clay, talcum, pumice, gypsum, perlite, chalk, and combinations thereof.

21. The process of claim 16, wherein the coating of the guayule seeds of (a) is present in an amount of 40 to 3 grams per gram of seed.

22. The process of claim 16, further comprising irrigating the applied guayule seeds.

23. The process of claim 16, wherein the guayule seeds of (a) have been subjected to gibberellic acid treatment prior to being coated.

24. The process of claim 16, wherein the insecticide is selected from at least one of clothianidin, acetamiprid, nitenpyram, nithiazine, and thiacloprid.

25. The process of claim 16, wherein (c) comprises applying the guayule seeds of (a) in spaced intervals to rows of soil wherein each row is spaced about 20 to about 80 inches apart and locations within rows are spaced about 0.5 to about 36 inches apart.

26. The process of claim 25, wherein the rows of soil further comprise one or more depressions upon which the guayule seeds of (a) are applied.

27. The process of claim 16, wherein (c) comprises mechanical application to at least 2 acres/hour of the field.

28. A process for direct seeding of guayule seeds into a field comprising
a. providing a quantity of guayule seeds;
b. providing a field comprising soil with a surface;
c. coating the quantity of guayule seeds from (a) with a coating-mixture comprising at least one insecticide and one or more inert substances to provide coated guayule seeds;
d. applying the coated guayule seeds of (c) to the surface of the soil at multiple locations; and
e. allowing the guayule seeds of (d) to germinate into seedlings.

29. The process of claim 28, wherein the applied guayule seeds of (c) are pressed into the soil and covered with soil to a depth of no more than 1 inch.

30. The process of claim 28, wherein (d) results in a stand count of at least 1 seedling/m².

31. The process of claim 28, wherein the coating comprises a majority by weight of one or more inert substances selected from clay, talcum, pumice, gypsum, perlite, chalk, and combinations thereof.

32. The process of claim 28, wherein the coating of the guayule seeds of (a) is present in an amount of 40 to 3 grams per gram of seed.

33. The process of claim 28, wherein the insecticide is selected from at least one of clothianidin, acetamiprid, nitenpyram, nithiazine, and thiacloprid.

34. The process of claim 28, wherein (c) comprises
applying the guayule seeds of (a) in spaced intervals to rows of soil wherein each row is spaced about 20 to about 80 inches apart, locations within rows are spaced about 0.5 to about 36 inches apart, and wherein the rows of soil include one or more depressions upon which the guayule seeds of (a) are applied and
mechanical application to at least 2 acres/hour of the field.

35. A field direct seeded with guayule according to the process of claim 16.
